(19) United States
(12) Patent Application Publication
(10) Pub. No.: US 2010/0304911 A1
(43) Pub. Date: Dec. 2, 2010

(54) VIBRATION-PROOF SILENT CHAIN

(75) Inventor: Tsuyoshi Kabai, Osaka (JP)

Correspondence Address: HOWSON & HOWSON LLP, 501 OFFICE CENTER DRIVE, SUITE 210, FORT WASHINGTON, PA, 19034, US

(73) Assignee: c/o Tsubakimoto Chain Co., Osaka (JP)

(21) Appl. No.: 12/771,000

(22) Filed: Apr. 30, 2010

(30) Foreign Application Priority Data
May 26, 2009 (JP) 2009-126461

(51) Int. Cl. F16G 13/04

(52) U.S. Cl. 474/213

(57) ABSTRACT

In a silent chain, the toothed link plates are configured so that their centers of gravity are aligned with the line of action of chain tension in a free span of the chain, when the free span is straight and under tension. The positions of the centers of gravity are aligned with the centers of the pin holes in the case of a chain incorporating round connecting pins and are aligned with the points of contact of the rocker pins and joint pins in the case of a chain having rocker joint connecting pins. Positioning of the centers of gravity can be effected by thickening the backs of the link plates or by providing weight-reducing holes in the vicinity of the teeth of the link plates.

### CROSS REFERENCE TO RELATED APPLICATIONS

This application claims priority, under Title 35, United States Code, §119 (a)-(d), on the basis of Japanese Patent Application No. 2009-126461, filed on May 26, 2009. The disclosure of Japanese Patent Application No. 2009-126461 is herein incorporated by reference in its entirety.

### FIELD OF THE INVENTION

This invention relates to a silent chain for the use as a timing chain in an automobile engine and as a power transmission chain in industrial machinery, for example.

### BACKGROUND OF THE INVENTION

FIG. 8 of the drawings shows a known silent chain 500 for use in an engine or other mechanism requiring power transmission. The silent chain is composed of rows of link plates, each row comprising a plurality of link plates 510 arranged in side-by-side, spaced relationship in the direction of the width of the chain. The plates of the rows are interleaved and linked by connecting pins 520 inserted through pin holes in the link plates. The link plates are bifurcated to form sprocket-engaging teeth, and the chain transmits power from one sprocket S to another by engagement of teeth of the link plates with teeth (not shown) of the sprockets. As the link plate 510 approaches a sprocket, an inner tooth flank starts to engage with a sprocket tooth S. Thereafter, the outer tooth flanks of the link plate seat on the sprocket.

These link plates 510 are manufactured by punching a sheet of blank steel to form pin holes, moving the blank steel to a new position in a punching press, and there punching the profile of the link plate, which includes the inner tooth flanks, the outer tooth flanks, and the back surface. Alternatively, by adopting the reverse sequence, the profile can be formed first and the pin holes formed thereafter. A typical link plate is described in United States Patent publication 2007/0161445, published on Jul. 12, 2007.

Efforts have been made to reduce noise and improve wear resistance in silent chains by improving punching accuracy and dimensional accuracy. However, in conventional chains, and even in chains produced using techniques to improve dimensional accuracy, as shown in FIGS. 8-10, the centers of gravity G of the link plates are spaced from the line CL along which tensile force acts on the chain, as shown in FIGS. 8-10. The deviation of the center of gravity from the line of action of the tensile force produces disturbances in the travel of the chain in a free span FS of the chain between the sprockets.

In a chain transmission, the free spans FS between sprockets move inward and outward in a direction such as to contract or expand the loop formed by the chain, due to so-called “polygonal action,” also known as “chordal action,” generated as the chain disengages from a sprocket. Chordal action causes fluctuations in the tensile forces T1 and T2 acting on the link plates of the chain, as shown in FIG. 10. When the centers of gravity of the link plates deviate from the line of action of the tensile force, fluctuations in the tensile force induce vibration in a direction orthogonal to the direction of the tensile force. The vibratory force is designated V in the auxiliary enlargement in FIG. 10. The vibratory force V causes “string vibration” in the free span FS of the chain, which is a main cause of vibration noise, and inhibits stable travel of the chain. String vibration has been a cumbersome problem in the transmission of power using silent chains.

### SUMMARY OF THE INVENTION

The invention addresses the above-described problem above by providing a vibration-proof silent chain in which string vibration is reduced so that the chain generates less vibration noise than a conventional silent chain and exhibits more stable chain travel.

The vibration-proof silent chain according to the invention comprising rows of link plates interleaved with one another and joined by connecting pins whereby the rows form an endless loop. The link plates of the chain have teeth for meshing engagement with sprockets to transmit power from one sprocket to another. When the link plates of the free span of the chain are maintained in a straight condition by tension in the chain, the centers of gravity of the toothed link plates of the free span in each column of toothed link plates are disposed in a line along which chain tension acts.

When the centers of gravity of the link plates are disposed in the line along which chain tension acts, even though chordal action causes the traveling line of the chain to move inward and outward in a direction to contract or expand the loop formed by the chain, the centers of gravity of the link plates are pulled only in the same direction as the connecting pins, and no vibratory forces acting in a direction orthogonal to the tensile direction are generated at the centers of gravity of the link plates. As a result, the chain eliminates string vibration that would otherwise be generated in the free spans, thereby reducing vibration noise and improving stability in the travel of the chain.

The advantages of the invention can be realized in a silent chain having round connecting pins. In such a chain, the chain tension acts along a line through the centers of the connecting pins. The advantages of the invention can also be realized in a silent chain having rocker joint pins, each composed of a rocker pin and a joint pin having mutually contacting rolling surfaces. In such a chain the chain tension acts along a line that intersects the contact lines of the rolling surfaces.

### BRIEF DESCRIPTION OF DRAWINGS

FIG. 1 is a schematic drawing of a vibration-proof silent chain according to a first embodiment of the invention;

FIG. 2 is an enlarged view of a link plate of the silent chain in FIG. 1;

FIG. 3 is a schematic view showing a relationship between a tensile force in a free span of the chain and the center of gravity of a link plate;

FIG. 4 is an enlarged view of a link plate according to a second embodiment of the invention, including a comparison with a conventional link plate;

FIG. 5 is an enlarged view of a link plate according to a third embodiment of the invention;

FIG. 6 is a drawing showing a vibration-proof silent chain according to a fourth embodiment of the invention;

FIG. 7 is an enlarged view of a link plate of the silent chain shown in FIG. 6;

FIG. 8 is a drawing showing a prior art silent chain;

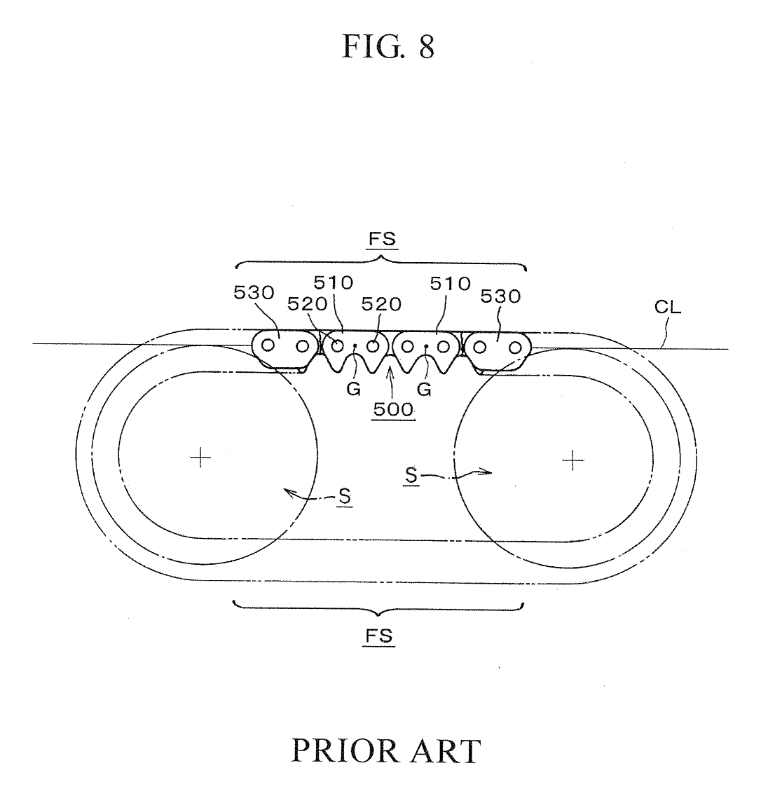

FIG. 9 is an enlarged view of a link plate of the prior art silent chain shown in FIG. 8; and

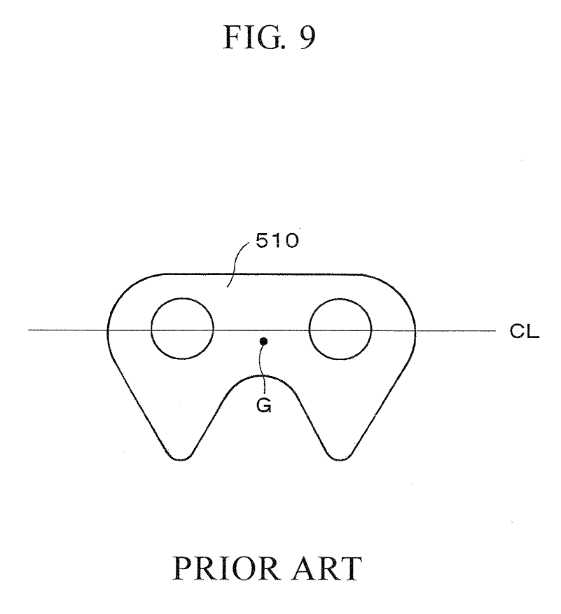

FIG. 10 is a schematic view showing the relationship between the tensile force of the chain of FIGS. 8 and 9 and the center of gravity of a plate in a free span of the chain.

### DETAILED DESCRIPTION OF THE PREFERRED EMBODIMENTS

The invention can be embodied in any of a variety of silent chains as long as the centers of gravity of the link plates are positioned along the line of action of chain tension in a straight free span. For instance, the link plates may have pairs of teeth extending toward the inside of the loop formed by the chain, or the chain may be a double-sided silent chain having teeth that protrude both toward the inside of the loop and toward the outside of the loop. The chain may be composed of link plates some or all of which are formed with weight reduction holes in the vicinity of the link teeth or in the vicinity of the backs of the plates. The chain may also be composed of link plates some or all of which have thickened parts in the vicinity of the link teeth or in the vicinity of the backs of the plates in order to improve wear resistance.

The invention is also applicable to silent chain transmissions of various engagement types, including, for example transmissions in which engagement takes place by contact between sprocket teeth and inner flanks of the chain and seating takes place by contact between sprocket teeth and outer flanks of the chain, as well as transmissions in which engagement takes place by contact between sprocket teeth and outer flanks of the chain and seating takes place by contact between sprocket teeth and outer flanks of the chain.

When link teeth of the inner flank engagement/outer flank seating type engage with sprocket teeth, an part of the inner flank of a front tooth, that is a tooth that is a front tooth of a link plate with reference to the advancing direction of the chain, contacts a sprocket tooth and slides toward the root of the sprocket tooth. The engagement shifts from the inner flank to the outer flank, and the outer flanks of the front and rear teeth of the link plate slid along the faces of sprocket teeth until the link plate is seated.

When link teeth of the outer flank engagement/outer flank seating type engage with sprocket teeth, a part of an outer flank near the tip of a rear tooth, that is, a tooth that is a rear tooth of a link plate with reference to the advancing direction of the chain, contacts a sprocket tooth and slides along the face of the sprocket tooth toward the sprocket tooth root. The outer flank of the front tooth of the same link plate also contacts a sprocket tooth, and both outer flanks become seated on the sprocket teeth.

The specific configuration of the link teeth in the vibration-proof silent chain of the invention can vary. For example, the teeth may have a straight tooth form or a curved tooth form. Preferably, the tooth forms should correspond to the tooth forms, in axial section, of the hob cutter used to produce the sprocket teeth. The inner flank preferably has a curved shape in the form of an arc for homogeneous dispersion of stress and avoidance of stress concentration.

The connecting pin used in the silent chain of the invention may be either a round pin having a circular section or a rocker joint pin composed of a rocker pin and a joint pin. When the round pin is used, it tends to contact the inner surface of a pin hole over an increased area without applying a biased load, so that wear is reduced and wear elongation of the chain is suppressed.

The line of action of the tensile force of the chain, i.e., the term “line along which chain tension acts,” as used herein, refers to a line along which tensile force acts in a substantially straight free span of the chain stretched between sprockets. When the connecting pins are round pins, the line is a center line mutually connecting centers of the round pins. When the connecting pins are rocker joint pins, the line along which chain tension acts is a center line connecting the mutually contacting rolling faces of successive pairs of rocker pins and joint pins.

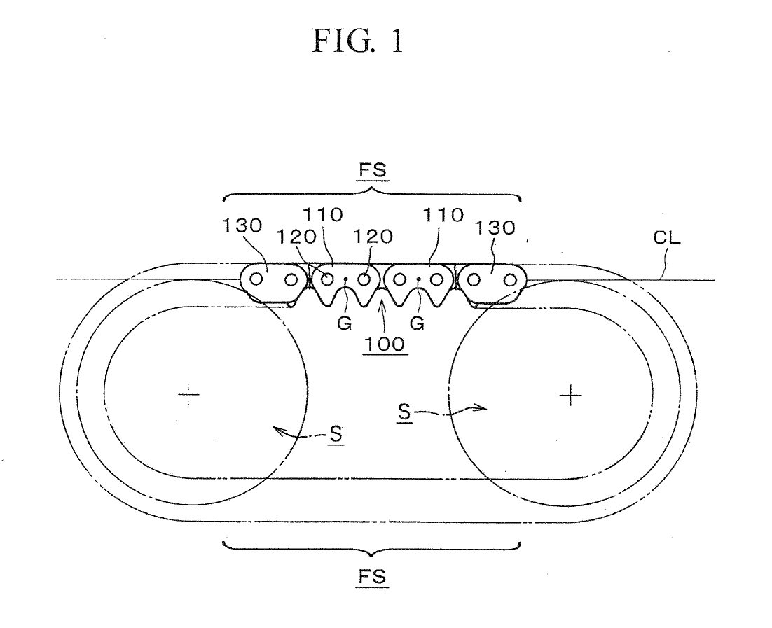

As shown in FIG. 1, the vibration-proof silent chain 100 of the includes a large number of toothed link plates 110 linked by round connecting pins 120 to form an endless loop for transmission of power form one sprocket S to another.

The chain also includes guide plates 130, disposed at the outermost sides of the chain. The ends of the connecting pins are press fit into pin holes in the guide plates, and extend rotatably through pin holes of the toothed link plates

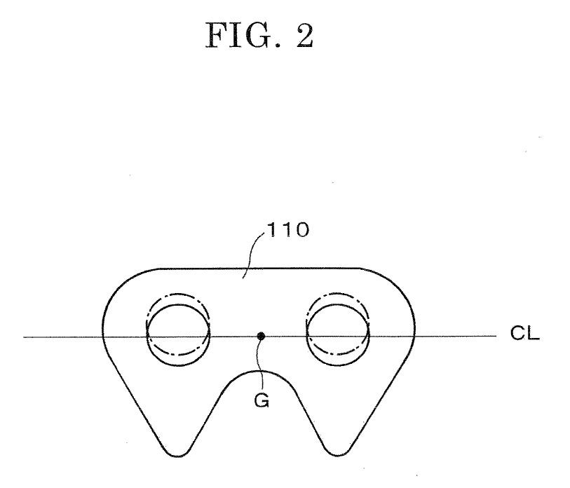

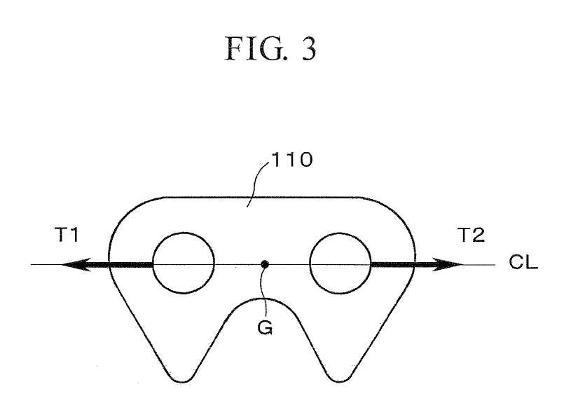

As shown in FIGS. 2 and 3, the center of gravity G of each link plate 110 is positioned on a chain tension acting line CL in the free span FS extending between the sprockets S in FIG. 1. Thus, the center of gravity G of the link plate 110 is disposed on a line extending in the longitudinal direction of the chain and connecting the centers of the connecting pins 120, which are round pins.

Circles drawn in broken lines in FIG. 2 depict the positions of pin holes in a prior art link plate. In that prior art link plate, the center of gravity will be below a line connecting the centers of its pin holes FIG. 2, and above, but very near, the position of center of gravity G of plate 110.

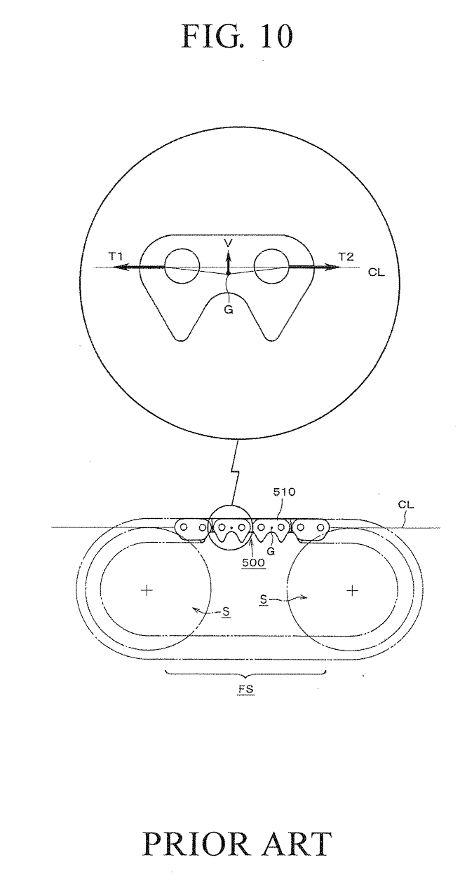

Even though the line of travel of the chain moves in and out with respect to the loop formed by the chain due to chordal action, the centers of gravity G of the link plates 110 move only in the same direction as the round connecting pins 120 (FIG. 1) and the tensile forces T1 and T2 shown in FIG. 3 act along a line intersecting the center of gravity G of the link plate, and therefore do not produce a vibratory force V as in FIG. 10, in a direction orthogonal to the tensile direction.

The inner flanks of the link plate 110 have the same shape as the profile in an axial sectional of a hob cutter used for cutting the teeth of a sprocket used with the chain. Thus, the inner flanks of the link plates 110 proceeding tangentially toward a sprocket can be accepted by the sprocket S without the travel line moving inward and outward, and can begin to engage the sprocket stable and smoothly. Although engagement shifts from the inner flank to the outer flank, the inner flank engagement time is sufficient to result in suppression of chordal action, which is also desirable.

Accordingly, the vibration-proof silent chain 100 of the first embodiment of the invention eliminates string vibration that would otherwise take place in the free spans FS between the sprockets S, reduces vibration noise that accompanies string vibration, and ensures stable chain travel.

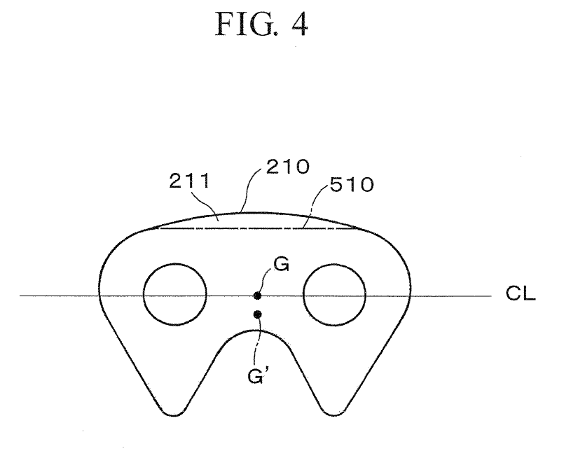

In the embodiment shown in FIG. 4, the center of gravity G of the link plate 210 is also positioned on the chain tension acting line CL in the free span of the chain, which also intersects the centers of the pin holes. In a conventional link plate 510, having its back configured as indicated by the broken line 510 in FIG. 4, the center of gravity would be at position G′. However, because the plate 210 is formed with an enlarged part 211 in the vicinity of the back of the link plate, which improves wear resistance, the center of gravity is moved to position G on the line CL along which chain tension acts.

Accordingly, while improving wear resistance of the back of the link plate 210, the chain of this second embodiment also eliminates string vibration that would otherwise occur in the free spans of the chain, and avoids vibration noise.

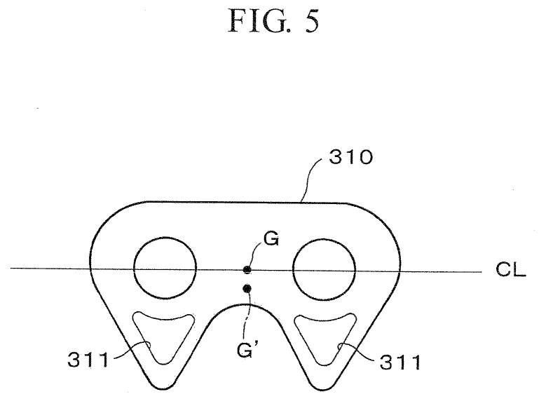

In the link plate 310 shown in FIG. 5, again the center of gravity G is positioned on the chain tension acting line CL in a free span of the chain, which also intersects the centers of the pin holes. The center of gravity G would be at position G′ except for the presence of weight-reducing holes 311 in the vicinity of the teeth of the link plate, which cause the center of gravity to move from position G′ to position G.

Accordingly, while reducing the weight of the link plate 310, the holes 311 also cause the center of gravity to become aligned with the tensile force action line, eliminating string vibration that would otherwise occur in the free span of the chain, reduces accompanying noise, and improves stability of chain travel.

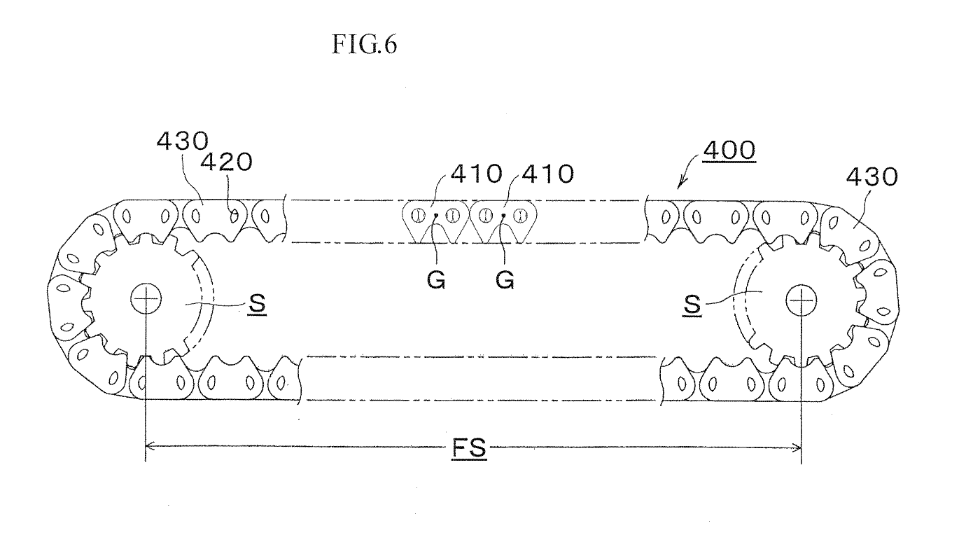

In a fourth embodiment shown in FIG. 6, a silent chain 400 includes a large number of link plates 410 linked by connecting pins 420 composed of rocker pins 421 and joint pins 422. Guide plates 430 in FIG. 6 are disposed on the outermost sides of the chain, and the ends of joint pins 422, which are longer than the rocker pins, are press-fit into pin holes in the guide plates. The rocker pins and joint pins fit through the holes in the toothed link plates in such a way that the rocker and joint pins can rock on each other, allowing articulating movement of the adjoining rows of link plates.

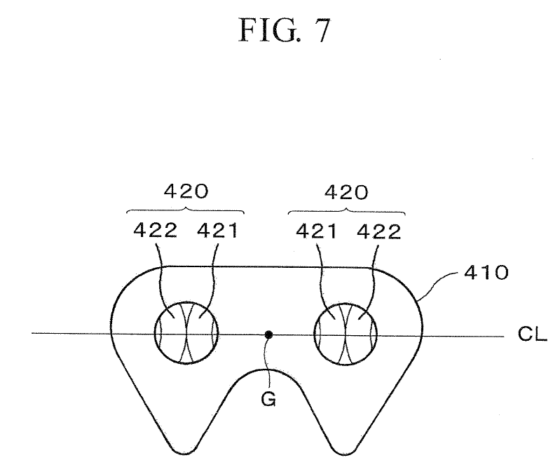

As shown in FIG. 7, the center of gravity G of the link plate 410 is positioned on the chain tension acting line CL in the free span of the chain, which, at least when the free span of the chain is straight and under tension, intersects the lines along which the rocker and joint pins contact each other.

Even if the traveling line of the chain moves inward and outward due to the chordal action, the centers of gravity G of the link plates 410 move only in the same direction in which the connecting pins 420 move, and vibratory forces in direction orthogonal to the direction in which the tensile forces act are suppressed.

Accordingly, the vibration-proof silent chain 400 of the fourth embodiment of the invention also eliminates string vibration, reduces the accompanying vibration noise and improves stability of chain travel.

What is claimed is:

1. A vibration-proof silent chain, comprising rows of link plates interleaved with one another and joined by connecting pins whereby the rows form an endless loop and the link plates of alternate rows are disposed in columns extending lengthwise of the chain, the link plates having teeth for meshing engagement with sprockets to transmit power from one sprocket to another, wherein, in any free span of the chain maintained in a straight condition by tension in the chain, the centers of gravity of the toothed link plates of the free span in each column of toothed link plates are disposed in a line along which chain tension acts.

2. The vibration-proof silent chain according to claim 1, wherein the connecting pins of the chain are round connecting pins, and wherein said line along which chain tension acts is a line connecting centers of said round connecting pins.

3. The vibration-proof silent chain according to claim 1, wherein the connecting pins are rocker joint pins, each composed of a rocker pin and a joint pin having mutually contacting rolling surfaces, and wherein, in said free span of the chain, the line along which chain tension acts intersects the contact lines of said rolling surfaces.
